(19) United States
(12) Patent Application Publication
(10) Pub. No.: US 2019/0057406 A1
(43) Pub. Date: Feb. 21, 2019

(54) ANALYSIS METHOD, ANALYSIS SYSTEM, AND STORAGE MEDIUM

(71) Applicant: Hitachi, Ltd., Tokyo (JP)

(72) Inventors: Shouta INOUE, Tokyo (JP); Jiro KATO, Tokyo (JP)

(21) Appl. No.: 15/757,981

(22) PCT Filed: Sep. 21, 2016
(86) PCT No.: PCT/JP2016/077908

§ 371 Date: Mar. 7, 2018

(51) Int. Cl. G06Q 30/02

(52) U.S. Cl. CPC G06Q 30/0202; G06Q 30/0205

(57) ABSTRACT

An analysis method to be performed by a computer, the computer holding information indicating attributes assigned to each of products, information indicating attributes assigned to each of stores, and information indicating sales of individual products at each store, and the analysis method comprising: a step of summing up the sales of the individual products at each store; a step of replacing sales of a first product at a first store with potential sales higher than the sales of the first product at the first store in a case where an attribute assigned to the first store corresponds to an attribute assigned to the first product and sales of the first product at some store assigned the attribute is higher than the sales of the first product at the first store; and a step of outputting information indicating sales ranks of the individual products at the first store after the replacement.

### BACKGROUND OF THE INVENTION

This invention relates to technology to analyze product sales of stores.

Background art of this invention includes WO 2015/040789 A, which states: This invention discloses a product recommendation device that recommends products that are selling well in many stores, not products that are selling well in only some stores. For each of a plurality of products sold at a plurality of stores, a score computation unit computes a score that increases as a function of both shipment volume and the number of stores at which the product in question is being sold. A product recommendation unit recommends products that have higher scores than products being sold at the store for which the recommendation is being made.

### SUMMARY OF THE INVENTION

Conventionally, the products to be displayed are determined in view of good-selling products, like the aforementioned WO 2015/040789 A. However, the actual trends of customers' preferences can be different store by store; the potential for future sales of a product at a given store may depend on the trend, even if the product is not selling well. If such a product that is not selling well is excluded from the display without exception, some store does not have the product many customers of the store will like and as a result, those customers may give up shopping there. Problems arise such that the customers lose their opportunity to purchase the product and that the store suffers from customer defection.

To solve the foregoing problem, provided is an analysis method to be performed by a computer including a processor and a storage device to be accessed by the processor, the storage device holding information indicating attributes assigned to each of a plurality of products, information indicating attributes assigned to each of a plurality of stores, and information indicating sales of individual products at each store, and the analysis method comprising: a first step of summing up, by the processor, the sales of the individual products at each store; a second step of replacing, by the processor, sales of a first product at a first store with potential sales higher than the sales of the first product at the first store in a case where an attribute assigned to the first store corresponds to an attribute assigned to the first product and sales of the first product at some store assigned the attribute corresponding to the attribute assigned to the first product is higher than the sales of the first product at the first store, the first product being one of the plurality of products, and the first store being one of the plurality of stores; and a third step of outputting, by the processor, information indicating sales ranks of the individual products at the first store after completion of the replacement with the potential sales.

An aspect of this invention enables prioritization in displaying products, considering the consumers' risk of losing the opportunity to purchase a product. The problems, configurations, and effects other than those described above will be clarified by the following description of embodiments.

### BRIEF DESCRIPTION OF THE DRAWINGS

FIG. 1 is a block diagram for illustrating a configuration of an analysis system in Embodiment 1 of this invention.

FIG. 2 is a flowchart of processing to be performed by an analysis apparatus in Embodiment 1 of this invention.

FIG. 3 is an explanatory diagram of a product master table held by the analysis apparatus in Embodiment 1 of this invention.

FIG. 4 is an explanatory diagram of a lifestyle attribute table held by the analysis apparatus in Embodiment 1 of this invention.

FIG. 5 is an explanatory diagram of a store master table held by the analysis apparatus in Embodiment 1 of this invention.

FIG. 6 is an explanatory diagram of a transaction detail table held by the analysis apparatus in Embodiment 1 of this invention.

FIG. 7 is a flowchart of processing to be performed by a store group assignment unit of the analysis apparatus in Embodiment 1 of this invention.

FIG. 8 is an explanatory diagram of a store lifestyle attribute calculation table held by the analysis apparatus in Embodiment 1 of this invention.

FIG. 9 is an explanatory diagram of a store lifestyle attribute assignment table held by the analysis apparatus in Embodiment 1 of this invention.

FIG. 10 is an explanatory diagram of a store grouping table held by the analysis apparatus in Embodiment 1 of this invention.

FIG. 11 is a flowchart of processing to be performed by a store-based ABC analysis calculation unit of the analysis apparatus in Embodiment 1 of this invention.

FIG. 12 is an explanatory diagram of a store-based ABC calculation table held by the analysis apparatus in Embodiment 1 of this invention.

FIG. 13 is a flowchart of processing to be performed by a product potential calculation unit of the analysis apparatus in Embodiment 1 of this invention.

FIG. 14 is an explanatory diagram of a store-lifestyle-attribute-based product potential calculation table held by the analysis apparatus in Embodiment 1 of this invention.

FIG. 15 is a flowchart of processing to be performed by a product display priority output unit of the analysis apparatus in Embodiment 1 of this invention.

FIG. 16 is an explanatory diagram of a store-based potential value reflection table held by the analysis apparatus in Embodiment 1 of this invention.

FIG. 17 is an explanatory diagram of a store-based product display priority table held by the analysis apparatus in Embodiment 1 of this invention.

FIG. 18 is a block diagram for illustrating a configuration of an analysis system in Embodiment 2 of this invention.

### DETAILED DESCRIPTION OF THE EMBODIMENTS

Hereinafter, embodiments of this invention will be described using the accompanying drawings.

### Embodiment 1

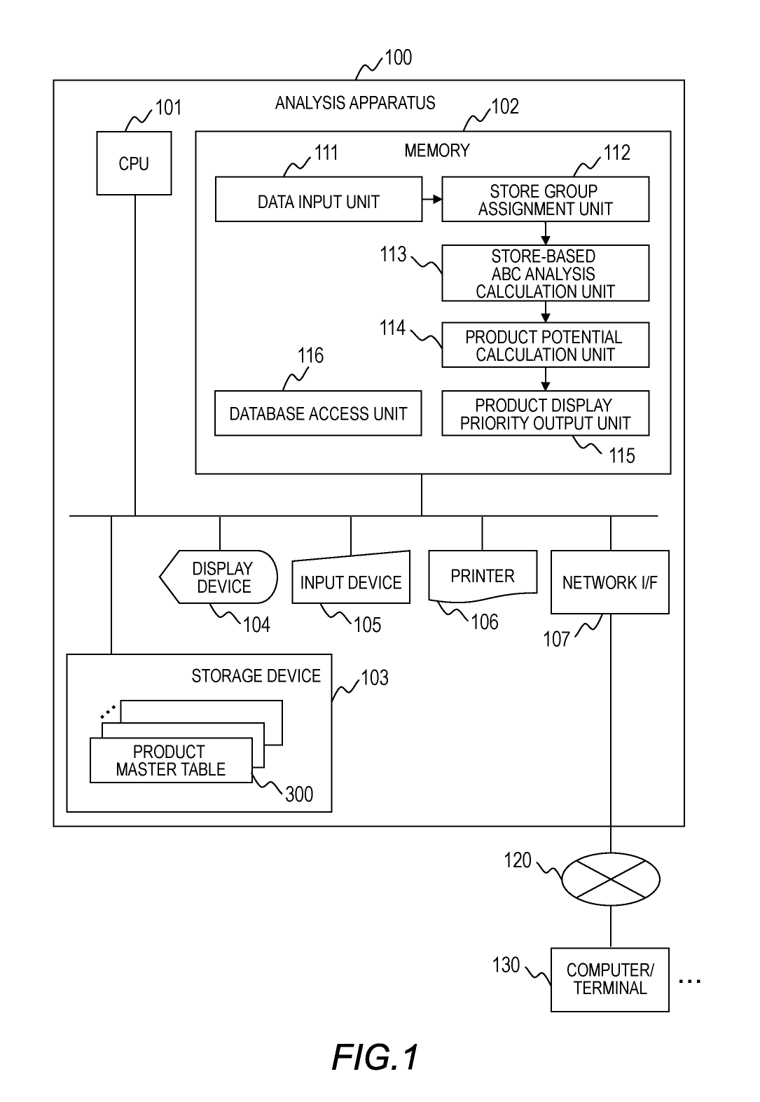

FIG. 1 is a block diagram for illustrating a configuration of an analysis system in Embodiment 1 of this invention.

The analysis system in this embodiment is configured with an analysis apparatus 100. The analysis apparatus 100 is a computer including a CPU 101, a memory 102, a storage device 103, a display device 104, an input device 105, a printer 106, and a network interface (I/F) 107 connected to be able to access one another.

The CPU 101 is a processor to implement various functions to be described later by executing programs stored in the memory 102.

The memory 102 is a primary storage device to store programs to be executed by the CPU 101 and other data. The memory 102 in this embodiment stores basic programs (not-shown) such as an operating system and in addition, programs to perform the functions of a data input unit 111, a store group assignment unit 112, a store-based ABC analysis calculation unit 113, a product potential calculation unit 114, a product display priority output unit 115, and a database access unit 116. In the following description, the processing performed by these units are actually performed by the CPU 101 controlling the components in the analysis apparatus 100 as necessary in accordance with the programs stored in the memory 102.

The storage device 103 may be a hard disk drive, for example, and stores data such as a product master table 300. At least part of the data stored in the storage device 103 may be copied to the memory 102 as necessary. The programs to be executed by the CPU 101 are also stored in the storage device 103 and at least a part of them may be copied to the memory 102 as necessary. The details of the data stored in the storage device 103 will be described later.

The display device 104 and the printer 106 are output devices to output results of processing performed by the CPU 101; they are capable of outputting desirable visual information by text and/or figure.

The input device 105 is a device for the user of the analysis apparatus 100 to input information to the analysis apparatus 100; it may be a keyboard, a mouse, or a touch panel.

The network I/F 107 is connected with a network 120 and communicates data with other apparatuses, for example, one or more computers/terminals 130.

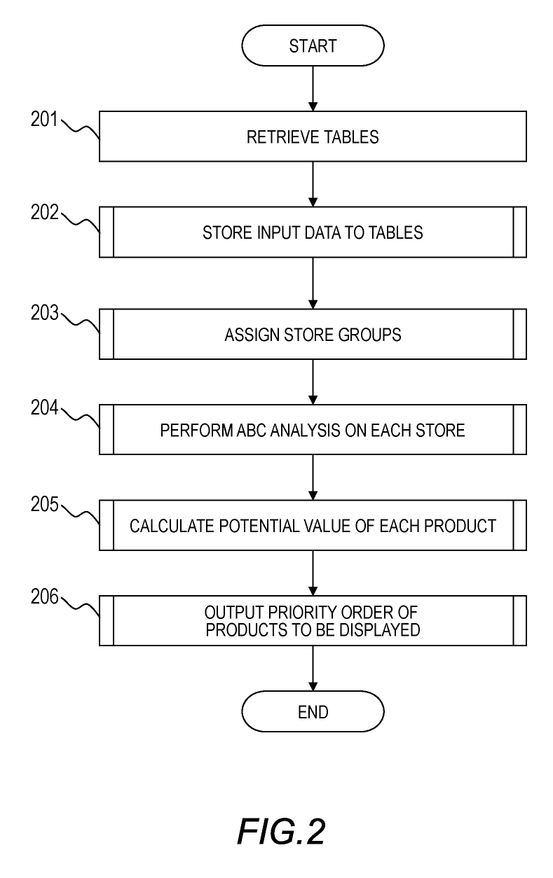

FIG. 2 is a flowchart of processing to be performed by the analysis apparatus 100 in Embodiment 1 of this invention.

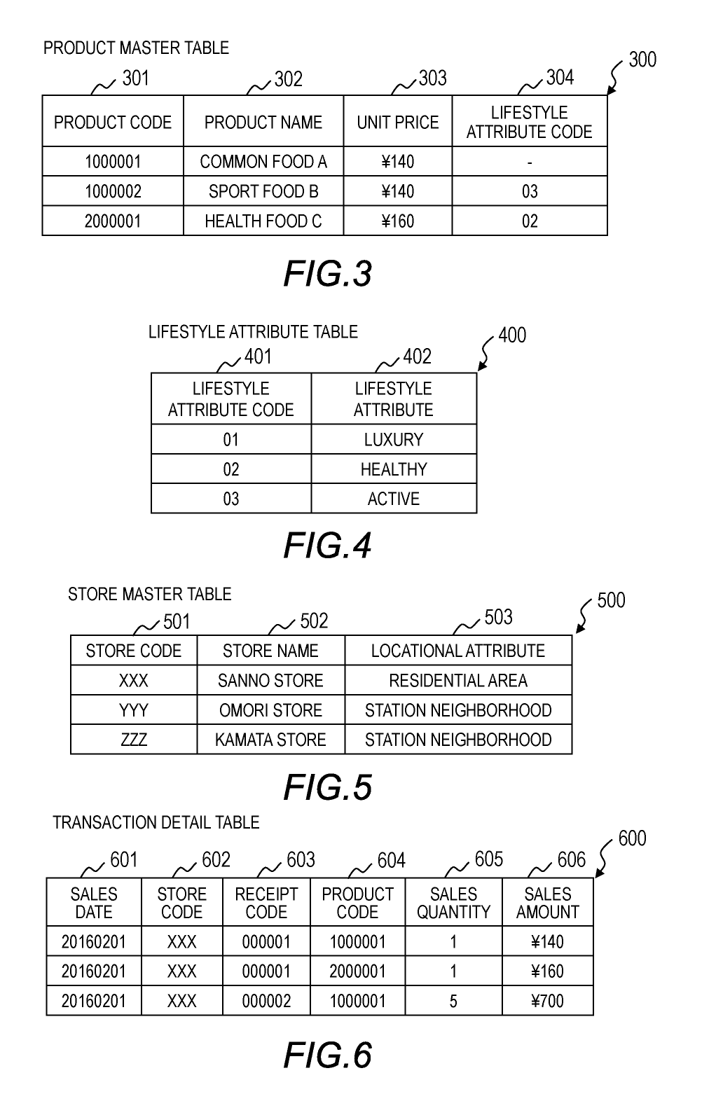

First, the database access unit 116 retrieves tables from the storage device 103 (Step 201). The tables to be retrieved at this step will be described later with reference to FIGS. 3 to 6.

Next, the data input unit 111 stores data input through the input device 105 to the tables (Step 202). For example, when information for filling the tables retrieved at Step 201 or parameters to be used in the subsequent processing are input through the input device 105, they are stored to the tables. Step 202 may be omitted if unnecessary.

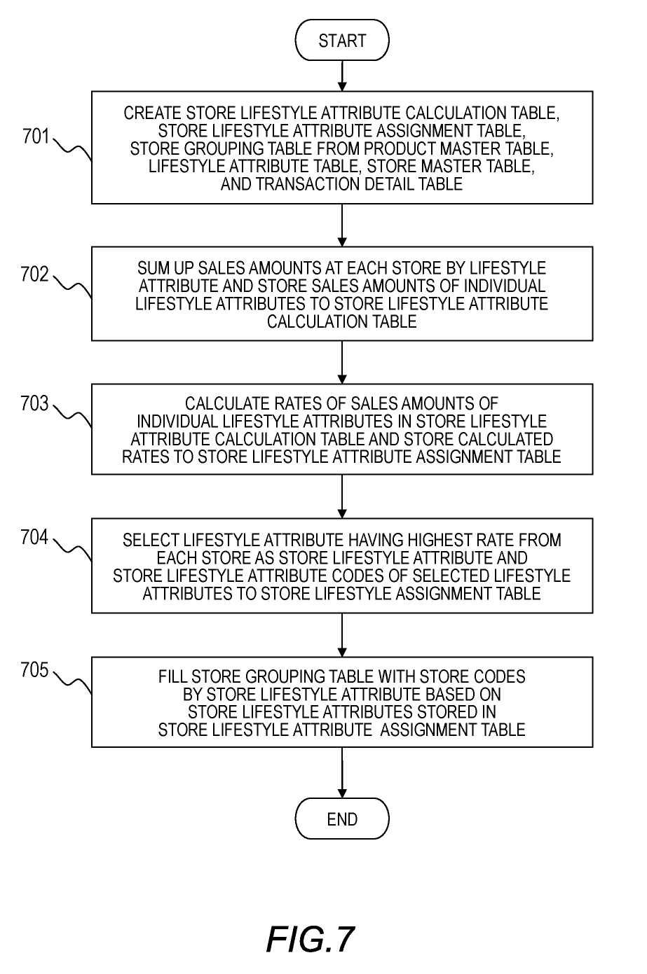

Next, the store group assignment unit 112 separates stores into store groups based on the tables retrieved at Step 201 and the data input at Step 202 (Step 203). The details of this processing will be described later with reference to FIGS. 7 to 10.

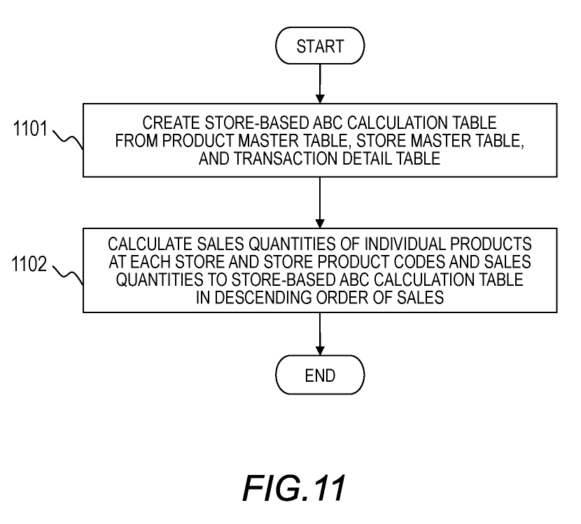

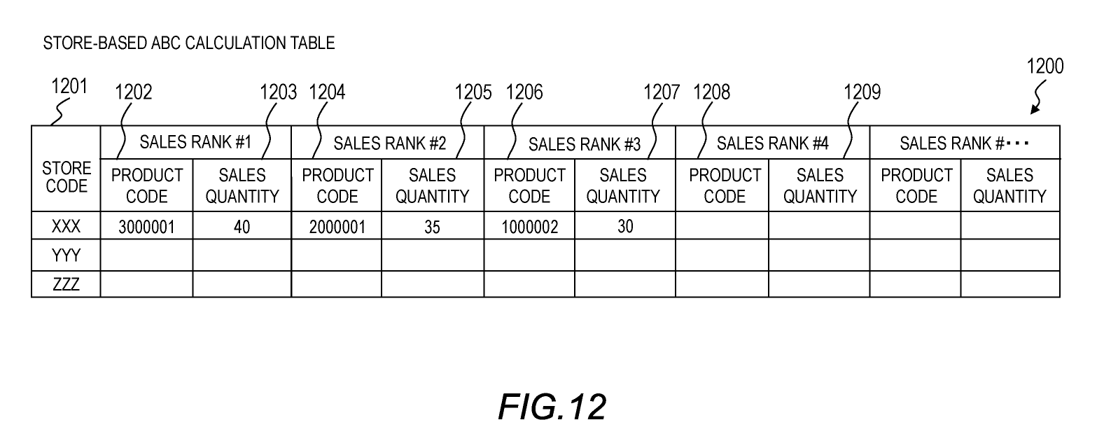

Next, the store-based ABC analysis calculation unit 113 performs ABC analysis on each store (Step 204). The details of this processing will be described later with reference to FIGS. 11 and 12.

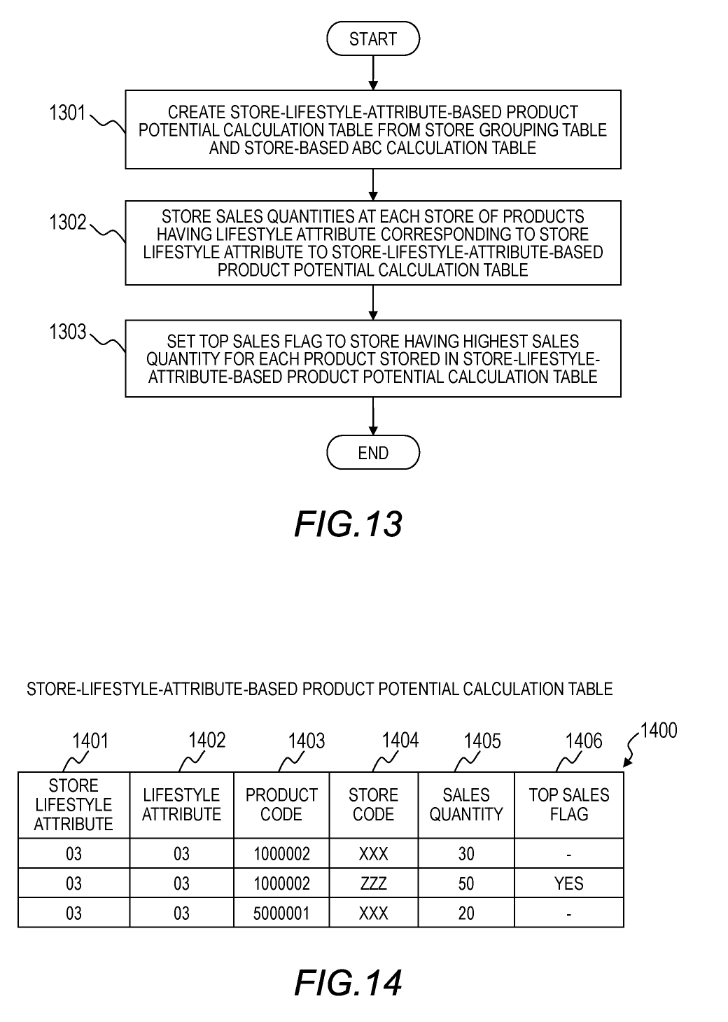

Next, the product potential calculation unit 114 calculates potentials for sales of individual products in the stores based on the result of the grouping at Step 203 and the result of the analysis at Step 204 (Step 205). The details of this processing will be described later with reference to FIGS. 13 and 14.

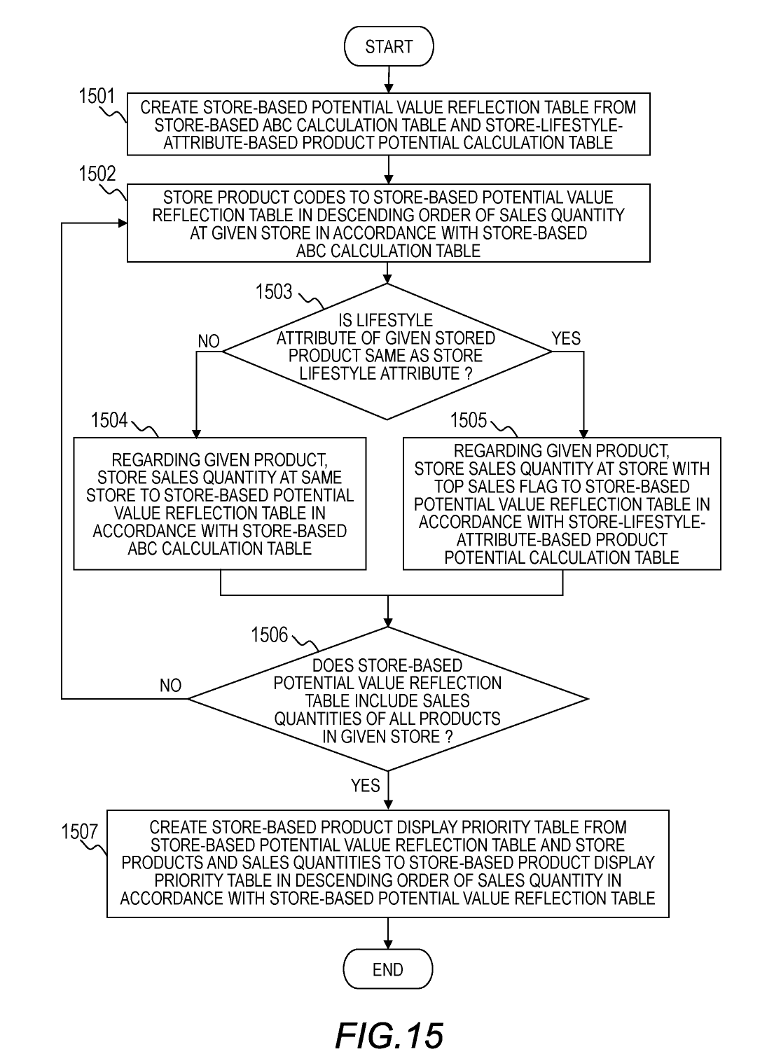

Finally, the product display priority output unit 115 determines the priority order of the products to be displayed based on the potentials calculated at Step 205 and outputs the priority order (Step 206). The details of this processing will be described later with reference to FIGS. 15 to 17.

FIG. 3 is an explanatory diagram of a product master table 300 held by the analysis apparatus 100 in Embodiment 1 of this invention.

The product master table 300 is stored in the storage device 103 of the analysis apparatus 100 and retrieved at Step 5201. At least a part of this table may be copied and stored to the memory 102 as necessary.

The product master table 300 includes information on attributes of each product; for example, the table 300 includes a product code 103, a product name 302, a unit price 303, and a lifestyle attribute code 304 of each product. The product code 301 is a code for uniquely identifying the product. The product name 302 is the name of the product. Although FIG. 3 includes names such as “Common Food A” as the product names 302 by way of example, specific product names may be entered in actual cases. The unit price 303 is a unit price of the product. The lifestyle attribute code 304 is a code for identifying an attribute preassigned to the product. In this embodiment, each product is assigned an attribute (hereinafter, lifestyle attribute) representing the lifestyle presumed for the buyers of the product. Examples of the lifestyle attribute in this embodiment will be described later with reference to FIG. 4.

FIG. 4 is an explanatory diagram of a lifestyle attribute table 400 held by the analysis apparatus 100 in Embodiment 1 of this invention.

The lifestyle attribute table 400 is stored in the storage device 103 of the analysis apparatus 100 and retrieved at Step 5201. At least a part of this table may be copied and stored to the memory 102 as necessary.

The lifestyle attribute table 400 includes information on lifestyle attributes; for example, the table 400 includes lifestyle attribute codes 401 and lifestyle attributes 402. Each life style attribute code 401 is a code for identifying an attribute preassigned to products and corresponds to a lifestyle attribute code 304 in FIG. 3. Each lifestyle attribute 402 indicates a lifestyle attribute associated with the code. In the example of FIG. 4, “Luxury”, “Healthy”, and “Active” are registered as lifestyle attributes 402 for the values “01”, “02”, and “03”, respectively, of lifestyle attribute codes 401.

Now, cross-referencing FIG. 3 with FIG. 4, it can be seen that the product “Common Food A” is not assigned any lifestyle attribute. The products “Sport Food B” and “Health Food C” are assigned lifestyle attributes of “Active” and “Healthy”, respectively. These indicates that Sport Food B is assigned an attribute indicating that the product tends to be purchased by people having an active lifestyle or people who like active lives by regularly enjoying sports, for example, and that Health Food C is assigned an attribute indicating that the product tends to be purchased by people having a health-conscious lifestyle or people who like healthy lives by paying attention to food additives and nutritional balance, for example. Common Food A is not assigned any attribute in this example.

The foregoing attributes assigned to the products are merely examples; in addition to or other than the foregoing attributes, a lifestyle attribute indicating that the product is preferred by people following the fashion, a lifestyle attribute indicating that the product is preferred by people who like inexpensive products, or an attribute not applicable to any lifestyle may be assigned.

FIG. 5 is an explanatory diagram of a store master table 500 held by the analysis apparatus 100 in Embodiment 1 of this invention.

The store master table 500 is stored in the storage device 103 of the analysis apparatus 100 and retrieved at Step S201. At least a part of this table may be copied and stored to the memory 102 as necessary.

The store master table 500 includes information on attributes of each store; for example, the table 500 includes a store code 501, a store name 502, and a locational attribute 503 of each store. The store code 501 is a code for uniquely identifying the store. The store name 502 is the name of the store. The locational attribute 503 is an attribute about the location of the store, such as residential area or station neighborhood.

FIG. 6 is an explanatory diagram of a transaction detail table 600 held by the analysis apparatus 100 in Embodiment 1 of this invention.

The transaction detail table 600 includes information on each product actually sold at each store; for example, each entry includes a sales date 601, a store code 602, a receipt code 603, a product code 604, a sales quantity 605, and a sales amount 606. The sales date 601 indicates the date on which a product is sold. The store code 602 is a code for uniquely identifying the store where the product is sold and corresponds to a store code 501 in FIG. 5. The receipt code 603 is a code for uniquely identifying a receipt including the sales record of the product. The product code 604 is a code for uniquely identifying the sold product and corresponds to a product code 301 in FIG. 3. The sales quantity 605 indicates the quantity of the sold product. The sales amount 606 indicates the sales amount of the sold product.

The above-described information for the transaction detail table 600 can be acquired from, for example, a point of sales (POS) system installed in the stores. For this reason, the transaction detail table 600 may be stored in advance in the storage device 103 of the analysis apparatus 100 and retrieved at Step 201 or alternatively, may be retrieved from each computer/terminal 130 holding the data of the POS system at Step 201 using the network I/F 107 and the network 120. At least part of the retrieved data may be copied and stored to the memory 102.

FIG. 7 is a flowchart of processing to be performed at Step 203 in FIG. 2 by the store group assignment unit 112 of the analysis apparatus 100 in Embodiment 1 of this invention.

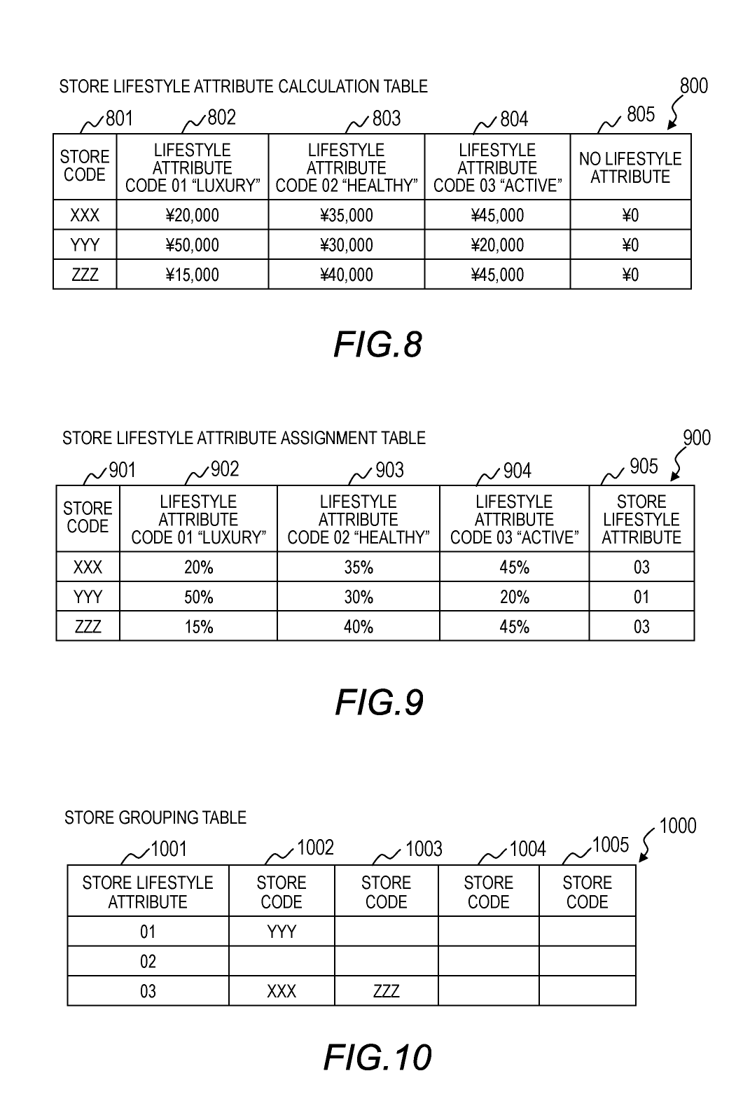

First, the store group assignment unit 112 creates a store lifestyle attribute calculation table 800 (see FIG. 8), a store lifestyle attribute assignment table 900 (see FIG. 9), and a store grouping table 1000 (see FIG. 10) based on the product master table 300, the lifestyle attribute table 400, the store master table 500, and the transaction detail table 600 (Step 701). These tables may be stored to either the memory 102 or the storage device 103. The details of these tables will be described later.

Next, the store group assignment unit 112 sums up the sales (for example, the sales amounts) at each store by lifestyle attribute with reference to the store lifestyle attribute calculation table 800 and stores the sales summed up by lifestyle attribute to the store lifestyle attribute calculation table 800 (Step 702).

Next, the store group assignment unit 112 calculates the rates of the sales of individual lifestyle attributes stored in the store lifestyle attribute calculation table 800 and stores the calculated rates to the store lifestyle attribute assignment table 900 (Step 703).

Next, the store group assignment unit 112 selects the lifestyle attribute having the highest rate from each store with reference to the store lifestyle attribute assignment table 900, determines the selected lifestyle attribute to be the lifestyle attribute of the store, and stores the lifestyle attribute code of the determined lifestyle attribute to the store lifestyle attribute assignment table 900 (Step 704).

Next, the store group assignment unit 112 fills the store grouping table 1000 with store codes for identifying individual stores by store lifestyle attribute based on the store lifestyle attributes stored in the store lifestyle attribute assignment table 900 (Step 705).

Through the foregoing operations, the processing of the store group assignment unit 112 is completed.

FIG. 8 is an explanatory diagram of the store lifestyle attribute calculation table 800 held by the analysis apparatus 100 in Embodiment 1 of this invention.

The store lifestyle attribute calculation table 800 includes a store code 801, a lifestyle attribute code 01 “Luxury” 802, a lifestyle attribute code 02 “Healthy” 803, a lifestyle attribute code 03 “Active” 804, and a no lifestyle attribute 805 in each entry.

The store code 801 is a code for uniquely identifying a store and corresponds to a store code 501 in FIG. 5. The lifestyle attribute code 01 “Luxury” 802, the lifestyle attribute code 02 “Healthy” 803, and the lifestyle attribute code 03 “Active” 804 are total sales amounts of products assigned the lifestyle attributes of “Luxury”, “Healthy”, and “Active”, respectively, in a predetermined period at the store. The no lifestyle attribute 805 is a total sales amount of the products assigned no lifestyle attribute in the predetermined period at the store. These values are calculated at Step 702 in FIG. 7.

Although the example of FIG. 8 employs the total sales amount as the total number of sales, any value can be used as far as the value represents a sales record, such as the total quantity of the sold products. If attributes other than the aforementioned attributes are assigned to products, columns for those attributes are added to the store lifestyle attribute calculation table 800.

FIG. 9 is an explanatory diagram of the store lifestyle attribute assignment table 900 held by the analysis apparatus 100 in Embodiment 1 of this invention.

The store lifestyle attribute assignment table 900 includes a store code 901, a lifestyle attribute code 01 “Luxury” 902, a lifestyle attribute code 02

“Healthy” 903, a lifestyle attribute code 03 “Active” 904, and a store lifestyle attribute 905 in each entry.

The store code 901 is a code for uniquely identifying a store and corresponds to a store code 501 in FIG. 5. The lifestyle attribute code 01 “Luxury” 902, the lifestyle attribute code 02 “Healthy” 903, and the lifestyle attribute code 03 “Active” 904 are rates of the sales of the products assigned the lifestyle attributes of “Luxury”, “Healthy”, and “Active”, respectively, to the total sales in a predetermined period at the store. These values are calculated at Step 703 in FIG. 7. The store lifestyle attribute 905 is a lifestyle attribute of the store determined based on the rates of the sales. This is determined at Step 704 in FIG. 7.

Taking the example of a store having a store code 801 of “XXX” (hereinafter, simply referred to as Store XXX and the same applies to the other store codes) in FIG. 8, when the values of the lifestyle attribute code 01 “Luxury” 802, the lifestyle attribute code 02 “Healthy” 803, the lifestyle attribute code 03 “Active” 804, and the no lifestyle attribute 805 are JPY20,000, JPY35,000, JPY45,000, and JPY0, respectively, the rates of the sales amounts of individual attributes to the total sales amount JPY100,000 are calculated as 20%, 35%, and 45% and these values are stored to the lifestyle attribute code 01 “Luxury” 902, the lifestyle attribute code 02 “Healthy” 903, and the lifestyle attribute code 03 “Active” 904.

In this example, the rate of the sales amount of the products assigned the lifestyle attribute “Active” is the highest and accordingly, the store lifestyle attribute of Store XXX is determined to be “Active” and the corresponding lifestyle attribute code “03” is stored to the store lifestyle attribute 905 of Store XXX.

FIG. 10 is an explanatory diagram of the store grouping table 1000 held by the analysis apparatus 100 in Embodiment 1 of this invention.

The store grouping table 1000 includes a store lifestyle attribute 1001 and store codes 1002 to 1005 in each entry. The store lifestyle attribute 1001 is a code for identifying a store lifestyle attribute and the store codes 1002 to 1005 are codes for identifying stores assigned the store lifestyle attribute. For example, in the foregoing case where Store XXX is assigned the store lifestyle attribute “Active”, “XXX” is stored to the store code 1002 for the code “03” of the store lifestyle attribute “Active”. Although the example of FIG. 10 includes only the store codes 1002 to 1005, the actual store grouping table 1000 may have more columns for storing store codes.

FIG. 11 is a flowchart of processing to be performed at Step 204 in FIG. 2 by the store-based ABC analysis calculation unit 113 of the analysis apparatus 100 in Embodiment 1 of this invention.

First, the store-based ABC analysis calculation unit 113 creates a store-based ABC calculation table 1200 based on the product master table 300, the store master table 500, and the transaction detail table 600 (Step 1101). This table may be stored to either the memory 102 or the storage device 103. The details of the store-based ABC calculation table 1200 will be described later (see FIG. 12).

Next, the store-based ABC analysis calculation unit 113 calculates the sales of individual products at each store and stores the product codes and the calculated sales to the store-based ABC calculation table 1200 in descending order of sales (Step 1102).

Through the foregoing operations, the processing of the store-based ABC analysis calculation unit 113 is completed.

FIG. 12 is an explanatory diagram of the store-based ABC calculation table 1200 held by the analysis apparatus 100 in Embodiment 1 of this invention.

The store-based ABC calculation table 1200 includes a store code 1201 and combinations of the product code and sales quantity of products with individual sales ranks in each entry. Although the example of FIG. 12 includes a product code 1202 and a sales quantity 1203 of a product with sales rank #1, a product code 1204 and a sales quantity 1205 of a product with sales rank #2, a product code 1206 and a sales quantity 1207 of a product with sales rank #3, and a product code 1208 and a sales quantity 1209 of a product with sales rank #4, the store-based ABC calculation table 1200 may include product codes and sales quantities of lower ranked products.

Taking the example of FIG. 12, the first sales rank at Store XXX is the sales quantity “40” of the product having a product code “3000001” and therefore, values “3000001” and “40” are stored to the product code 1202 and the sales quantity 1203 for the sales rank #1 of Store XXX. In similar, the product codes and sales quantities of the products with the second and subsequent sales ranks at Store XXX and the product codes and sales quantities of the products with individual sales ranks at the other stores are calculated and their values are stored to the corresponding fields (Step 1102 in FIG. 11).

Although the above-described example of FIGS. 11 and 12 uses the sales quantity (in other words, the number of sold pieces) of each product is used as the sales of the product at each store, the sales amount can be used in place of the quantity of the product as far as the value represents the sales record. The same applies to the processing described in the following.

FIG. 13 is a flowchart of processing to be performed at Step 205 in FIG. 2 by the product potential calculation unit 114 of the analysis apparatus 100 in Embodiment 1 of this invention.

First, the product potential calculation unit 114 creates a store-lifestyle-attribute-based product potential calculation table 1400 based on the store grouping table 1000 and the store-based ABC calculation table 1200 (Step 1301). This table may be stored to either the memory 102 or the storage device 103. The details of the store-lifestyle-attribute-based product potential calculation table 1400 will be described later (see FIG. 14).

Next, the product potential calculation unit 114 selects products assigned a lifestyle attribute corresponding to the store lifestyle attribute from each store and stores the sales quantities of the products at each store to the store-lifestyle-attribute-based product potential calculation table 1400 (Step 1302).

Next, the product potential calculation unit 114 determines the store having the highest sales quantity for each product stored in the store-lifestyle-attribute-based product potential calculation table 1400 and sets a top sales flag to the determined store (Step 1303).

Through the foregoing operations, the processing of the product potential calculation unit 114 is completed.

FIG. 14 is an explanatory diagram of the store-lifestyle-attribute-based product potential calculation table 1400 held by the analysis apparatus 100 in Embodiment 1 of this invention.

The store-lifestyle-attribute-based product potential calculation table 1400 includes a store lifestyle attribute 1401, a lifestyle attribute 1403, a product code 1403, a store code 1404, a sales quantity 1405, and a top sales flag 1406 in each entry.

The store lifestyle attribute 1401 is a code for identifying a lifestyle attribute of a store and corresponds to a store lifestyle attribute 905 in FIG. 9. The lifestyle attribute 1402 is a code for identifying a lifestyle attribute assigned to a product and corresponds to a lifestyle attribute code 304 in FIG. 3. The product code 1403 is a code for identifying a product and corresponds to a product code 301 in FIG. 3. The store code 1404 is a code for identifying a store and corresponds to a store code 501 in FIG. 5. The sales quantity 1405 indicates the sales quantity of the product at the store and corresponds to a sales quantity 1203 in FIG. 12. The top sales flag 1406 is a flag to be set to the combination of a store and a product when the sales quantity of the product at the store is the highest as a result of comparison of the sales quantities of the product among a plurality of stores assigned the same lifestyle attribute as the product.

For example, the product potential calculation unit 114 stores the sales quantities of Sport Food B having a lifestyle attribute of “Active” (see FIG. 3) at the stores having a store lifestyle attribute of “Active” to the store-lifestyle-attribute-based product potential calculation table 1400 (Step 1302) and determines the highest sales quantity (Step 1303). In the example of FIG. 14, 30 pieces and 50 pieces of Sport Food B having the lifestyle attribute “Active” are sold at Store XXX and Store ZZZ having the store lifestyle attribute “Active”. If there is no other store having the store lifestyle attribute “Active” and having sold 50 or more pieces of Sport Food B having the lifestyle attribute “Active”, the top sales flag for Sport Food B is set to the sales quantity 50 at Store ZZZ (“Yes” in FIG. 14). The same processing as described above is performed on each combination of a store lifestyle attribute and a product assigned the same lifestyle attribute as the store lifestyle attribute.

FIG. 15 is a flowchart of processing to be performed at Step 206 in FIG. 2 by the product display priority output unit 115 of the analysis apparatus 100 in Embodiment 1 of this invention.

First, the product display priority output unit 115 creates a store-based potential value reflection table 1600 based on the store-based ABC calculation table 1200 and the store-lifestyle-attribute-based product potential calculation table 1400 (Step 1501). Next, the product display priority output unit 115 stores the product codes of the products sold at a given store to the store-based potential value reflection table 1600 together with the store code in descending order of sales quantity at the store in accordance with the store-based ABC calculation table 1200 (Step 1502).

Next, the product display priority output unit 115 determines whether the lifestyle attribute of each product stored in the store-based potential value reflection table 1600 is the same as the lifestyle attribute of the store of the entry (Step 1503).

If the determination at Step 1503 is that the lifestyle attribute of the product is not the same as the lifestyle attribute of the store, the product display priority output unit 115 stores the sales quantity of the product at the store to the store-based potential value reflection table 1600 in accordance with the store-based ABC calculation table 1200 (Step 1504).

If the determination at Step 1503 is that the lifestyle attribute of the product is the same as the lifestyle attribute of the store, the product display priority output unit 115 stores the sales quantity with the top sales flag among the sales quantities at the stores having the same lifestyle attribute as the store of the entry to the store-based potential value reflection table 1600 (Step 1505).

Next, the product display priority output unit 115 determines whether sales quantities for all products at the store have been stored in the store-based potential value reflection table 1600 (Step 1506). If there is some product for which the sales quantity has not been stored yet, the product display priority output unit 115 performs processing of Step 1502 and the subsequent steps on the product. If sales quantities of all products at the store have been stored, the product display priority output unit 115 creates a store-based product display priority table 1700 based on the store-based potential value reflection table 1600. The product display priority output unit 115 stores the product codes and sales quantities of the products at the store to the store-based product display priority table 1700 together with the store code in descending order of sales quantity in accordance with the store-based potential value reflection table 1600 (Step 1507).

Upon completion of the foregoing processing on all stores, the product display priority output unit 115 terminates the processing.

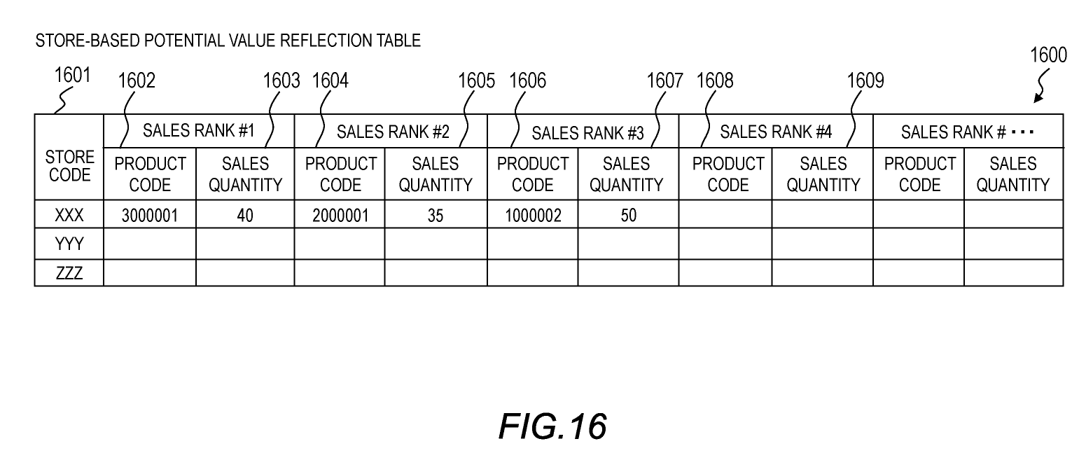

FIG. 16 is an explanatory diagram of the store-based potential value reflection table 1600 held by the analysis apparatus 100 in Embodiment 1 of this invention.

The store-based potential value reflection table 1600 includes a store code 1601 and combinations of the product code and sales quantity of products with individual sales ranks in each entry. Although the example of FIG. 16 includes a product code 1602 and a sales quantity 1603 of product with sales rank #1, a product code 1604 and a sales quantity 1605 of a product with sales rank #2, a product code 1606 and a sales quantity 1607 of a product with sales rank #3, and a product code 1608 and a sales quantity 1609 of a product with sales rank #4, the store-based potential value reflection table 1600 may include product codes and sales quantities of lower ranked products.

When Step 1502 in FIG. 15 is completed, the product codes and the sales quantities of the products with individual ranks at each store held in the store-based potential value reflection table 1600 are identical to those held in the store-based ABC calculation table 1200. Taking the example of the entry of Store XXX in FIG. 12 in which the sales quantity “40” of the product identified by the product code “3000001” ranks first, the sales quantity “35” of the product identified by the product code “2000001” ranks second, and the sales quantity “30” of the product identified by the product code “1000001” ranks third, the store-based potential value reflection table 1600 after Step 1502 includes “3000001” and “40” in the product code 1602 and the sales quantity 1603, respectively, for the rank #1, “2000001” and “35” in the product code 1604 and the sales quantity 1605, respectively, for the rank #2, and “1000002” and “30” in the product code 1606 and the sales quantity 1607, respectively, for the rank #3 in the entry of Store XXX.

In this example, the lifestyle attribute of the product “Sport Food B” identified by the product code “1000002” is determined to be the same “Active” as the lifestyle attribute of Store XXX (see FIGS. 3 and 10) at Step 1503. Accordingly, the product display priority output unit 1105 stores, with reference to the store-lifestyle-attribute-based product potential calculation table 1400, the value “50” in the sales quantity 1405 with the top sales flag 1406 set for the product code “1000002” to the sales quantity 1607 for the product code “1000002” (Step 1505).

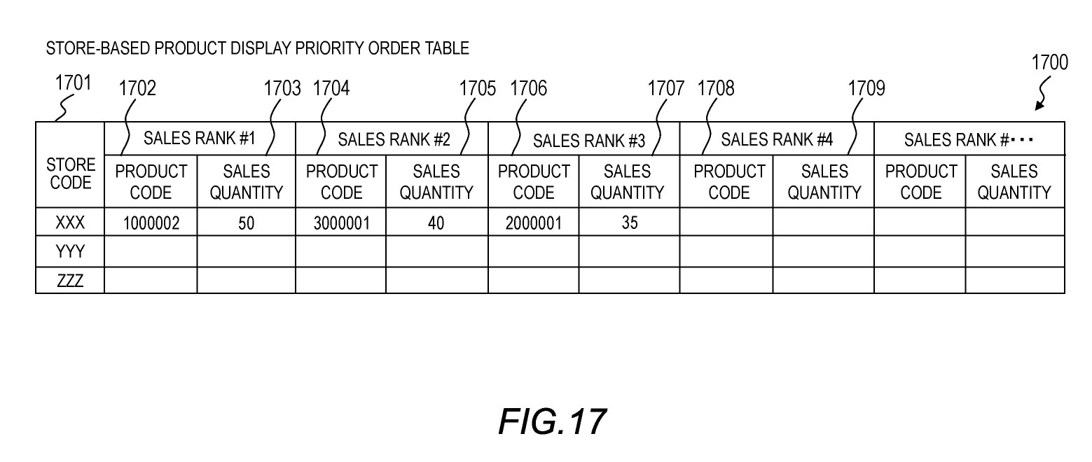

FIG. 17 is an explanatory diagram of the store-based product display priority table 1700 held by the analysis apparatus 100 in Embodiment 1 of this invention.

The store-based product display priority table 1700 includes a store code 1701 and combinations of the product code and sales quantity of products with individual sales ranks in each entry. Although the example of FIG. 17 includes a product code 1702 and a sales quantity 1703 of a product with sales rank #1, a product code 1704 and a sales quantity 1705 of a product with sales rank #2, a product code 1706 and a sales quantity 1707 of a product with sales rank #3, and a product code 1708 and a sales quantity 1709 of a product with sales rank #4, the store-based product display priority table 1700 may include product codes and sales quantities of lower ranked products.

Taking the example of FIG. 16, the sales rank of the product having a product code “1000002” at Store XXX is changed from #3 to #1 as a result of the change of the sales quantity of this product from “30” to “50”. For this reason, in the example of FIG. 17, values “10000002” and “50” are stored in the product code 1702 and the sales quantity 1703, respectively, for the sales rank #1, values “3000001” and “40” are stored in the product code 1704 and the sales quantity 1705, respectively, for the sales rank #2, and values “2000001” and “35” are stored in the product code 1706 and the sales quantity 1707, respectively, for the sales rank #3.

The product display priority output unit 115 may output information indicating the priority order of products at a given store determined as described above as an analysis result at Step 1507. Specifically, the analysis apparatus 100 may output the analysis result with the display device 104 or the printer 106 or send the analysis result to a selected computer/terminal 130 (for example, a terminal at the store that is going to utilize the analysis result in displaying products). The information indicating the priority order of products can be any information as far as the order of products can be identified; for example, only the sales ranking or the sales quantities according to the store-based product display priority table 1700 may be output.

The user of the analysis system of this embodiment can use this order as the priority order in displaying products at a store. For example, the user of the analysis system of this embodiment places products to the display space of the store from the product with the highest priority and determines not to display the products that do not fit in the display space.

As an option in the case where the priority order is changed in the above-described processing, the product display priority output unit 115 may output an attribute (such as locational attribute) other than the lifestyle attribute of the specific store from which the replacement sales quantity is acquired. Taking the example of Store XXX in FIGS. 16 and 17, since the sales quantity of the product having the product code “10000002” is changed from 30 to 50, the rank of this product is raised. Accordingly, the locational attribute 503 of Store ZZZ where the sales quantity of 50 is acquired may be output. Compared to the fact that Store XXX has a locational attribute of residential area, Store ZZZ has a locational attribute of station neighborhood. Accordingly, the user of the analysis system of this embodiment can determine, with reference to the locational attribute, that the difference in sales quantity is caused by the difference in locational attribute and further, determine not to adopt the provided priority order.

As described above, this embodiment assigns the same lifestyle attribute to the stores having similarities in sales trend of products-which product having which lifestyle attribute is selling well. For example, a store is assigned an attribute same as the attribute of the product with the highest sales rate at the store (Step 706 in FIG. 7). Accordingly, the stores assigned the same lifestyle attribute are more likely to be visited by customers having similar preferences and therefore, it can be said that products assigned the same lifestyle attribute as the store are likely to sell well.

This means the following: even if a product assigned the same lifestyle attribute as a store (for example, Store XXX) does not sell well at the store in a certain period, there is a possibility that the product will sell well at other stores assigned the same lifestyle attribute as far as the sales of the product at one of those stores (for example, Store ZZZ) is higher than the sales at Store XXX. That is to say, Store XXX has a possibility that the future sales of the product will become higher than the actual sales in the past. Accordingly, the above-described example replaces the sales of the product at Store XXX with potential sales higher than the actual sales (by storing the potential sales instead of the original sales to the store-based potential value reflection table 1600 at Step 1505 in FIG. 15) and determines the priority order for displaying products, based on the replaced sales.

As a result, the priority order for displaying products is determined so that a product determined to have a potential to sell well is less likely to be excluded from the display even if the product is not selling well. Accordingly, the consumers' risk to lose the opportunity to purchase the product can be reduced in view of the trend of the store.

The above-described example is configured to compare the sales quantities of a product in a plurality of stores assigned the same lifestyle attribute as the product and uses the highest value as potential sales (namely, a potential value). However, this value is an example and a value obtained by multiplying the highest value by a predetermined coefficient or an average or the like may be used as potential value. As a result, an appropriate potential value can be determined, although replacing with the potential value can be omitted if the determined potential value is lower than the original sales.

As an option, the analysis apparatus 100 in this embodiment may classify the products in the stores into products having high sales and products having low sales in accordance with predetermined criteria and perform the above-described processing only on the products having low sales. Specifically, the product display priority output unit 115 may omit Step 1503 of FIG. 15 and perform Step 1504 on the products having high sales. The loss of the consumers' opportunity to purchase a product by not displaying the product in a store is more likely to occur to a product having low sales and therefore, performing the above-described processing on such products can reduce the consumers' risk to lose the opportunity to purchase those products.

This embodiment is configured to execute Step 1505 of FIG. 15 only if the determination at Step 1503 is that the lifestyle attribute of the store is the same as the lifestyle attribute of the product; however, Step 1505 may be executed even if they are not the same. For example, as illustrated in FIG. 12, the lifestyle attribute of the product having a product code “2000001” with the sales rank #2 at Store XXX is “Healthy” (see FIG. 3), which is not the same “Active” as the lifestyle attribute of Store XXX. In this case, the product display priority output unit 115 at Step 1505 may replace the sales quantity “35” of this product with a potential value higher than that. Specifically, the product display priority output unit 115 may determine the potential value to replace based on the highest sales or another value of the product in the stores having the store lifestyle attribute “Healthy”.

In determining the potential value, the product display priority output unit 115 may assign weights to the actual sales, based on the sales rates of individual lifestyle attributes at the store. For example, in the case of Store XXX where the sales rate of the products assigned the lifestyle attribute “Active” is 45% and the sales rate of the products assigned the lifestyle attribute “Healthy” is 35% (see FIG. 9), the product display priority output unit 115 may acquire the sales quantities with top sales flags of the product having a product code “1000002” that is assigned the lifestyle attribute “Active” and the product having a product code “2000001” that is assigned the lifestyle attribute “Healthy”, multiplies the acquired sales quantities by coefficients corresponding to the rates of 45% and 35%, and determines the obtained values as potential values for the products.

The trend of the sales of a store does not always depend on only the attribute of the product accounting for the highest rate of sales; accordingly, it is expected that the above-described calculating the potential values for the products assigned attributes not accounting for the highest rate of sales will contribute to further reduction of the risks that the customers will lose their opportunity to purchase the product and that the store will suffer from customer defection.

### Embodiment 2

Embodiment 2 of this invention is described. Except for the differences described hereinafter, the elements in the system of Embodiment 2 have the same functions as the elements in Embodiment 1 denoted by the identical reference signs; accordingly, the explanation thereof is omitted.

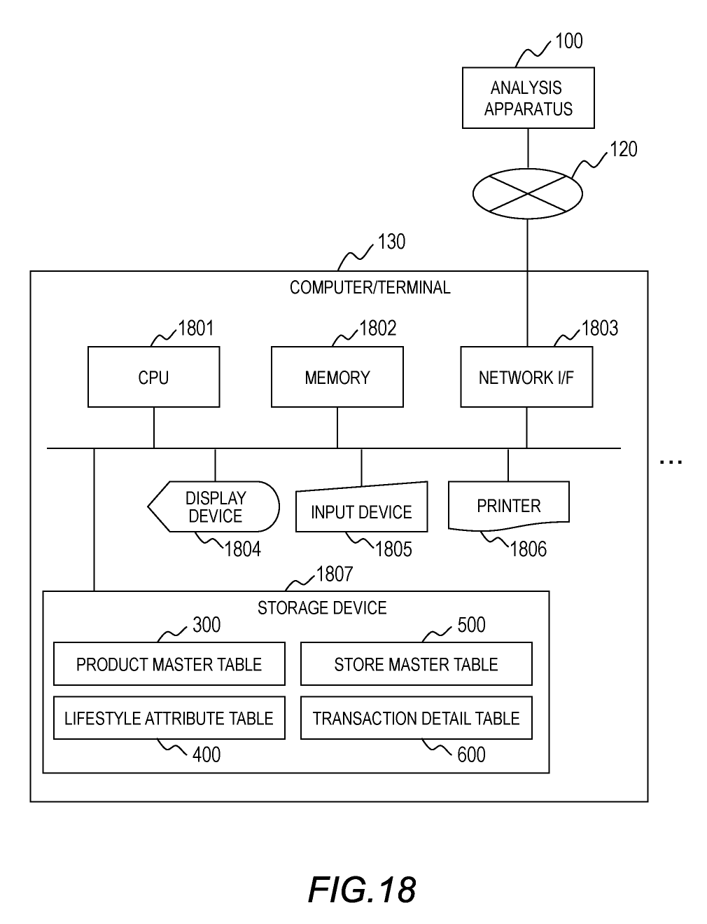

FIG. 18 is a block diagram for illustrating a configuration of an analysis system in Embodiment 2 of this invention.

The analysis system in this embodiment includes an analysis apparatus 100 and one or more computers/terminals 130 connected with one another through a network 120. Each computer/terminal 130 (hereinafter, simply referred to as terminal 130) includes a CPU 1801, a memory 1802, a network interface (I/F) 1803, a display device 1804, an input device 1805, a printer 1806, and a storage device 1807 connected to be able to access one another.

The CPU 1801 is a processor to implement various functions to be described later by executing programs stored in the memory 1802.

The memory 1802 is a primary storage device to store programs to be executed by the CPU 1801 and other data. The memory 1802 in this embodiment stores basic programs (not-shown) such as an operating system and in addition, a program (not-shown) to perform a function to send data such as a product master table 1811 and request analysis to the analysis apparatus 100, and receive and output a result of the analysis, for example.

The storage device 1807 may be a hard disk drive, for example, and stores data such as a product master table 300, a lifestyle attribute table 400, a store master table 500, and a transaction detail table 600.

The display device 1804 and the printer 1806 are output devices to output results of processing performed by the CPU 1801; they are capable of outputting desirable visual information by text and/or figure.

The input device 1805 is a device for the user of the terminal 130 to input information to the terminal 130; it may be a keyboard, a mouse, or a touch panel.

The network I/F 1803 is connected with the network 120 and communicates data with another apparatus, such as the analysis apparatus 100 or another terminal 130.

The terminal 130 in this embodiment sends the product master table 300, the lifestyle attribute table 400, the store master table 500, and the transaction detail table 600 and requests analysis to the analysis apparatus 100. The analysis apparatus 100 stores the received tables to the memory 102 or the storage device 103, performs the same processing as Embodiment 1, and outputs the result (for example, information in the store-based product display priority table 1700) with the display device 104 or sends the result to the terminal 130 via the network 120. In the latter case, the terminal 130 outputs the received processing result with the display device 1804 or the printer 1806.

In the example of FIG. 18, one terminal 130 holds the product master table 300, the lifestyle attribute table 400, the store master table 500, and the transaction detail table 600; however, these tables may be separately held by a plurality of terminals 130. For example, one terminal 130 may hold the product master table 300, the lifestyle attribute table 400, and the store master table 500 and another terminal 130 holds the transaction detail table 600, and each terminal 130 sends the tables held by itself to the analysis apparatus 100. Alternatively, each terminal 130 may hold a transaction detail table 600 including information about only one store and the analysis apparatus 100 combines transaction detail tables 600 received from the terminals 130 to generate a transaction detail table 600 including information about all stores.

The analysis apparatus 100 may be implemented with a plurality of computers connected with the network 120. In such a case, each step in FIG. 2 may be executed by a different computer.

It should be noted that this invention is not limited to the above-described embodiments but include various modifications. For example, the above-described embodiments provide details for the sake of better understanding of this invention; they are not limited to those including all the configurations as described. A part of the configuration of an embodiment may be replaced with a configuration of another embodiment or a configuration of an embodiment may be incorporated to a configuration of another embodiment. A part of the configuration of an embodiment may be added, deleted, or replaced by that of a different configuration.

The above-described configurations, functions, and processing units, for all or a part of them, may be implemented by hardware: for example, by designing an integrated circuit. The above-described configurations and functions may be implemented by software, which means that a processor interprets and executes programs providing the functions. The information of programs to perform the functions, tables, and files may be stored in a storage device such as a memory, a hard disk drive, or an SSD (Solid State Drive), or a storage medium such as an IC card or an SD card.

The drawings show control lines and information lines as considered necessary for explanations but do not show all control lines or information lines in the products. It can be considered that most of all components are actually connected with one another.

1. An analysis method to be performed by a computer including a processor and a storage device to be accessed by the processor,
the storage device holding information indicating attributes assigned to each of a plurality of products, information indicating attributes assigned to each of a plurality of stores, and information indicating sales of individual products at each store, and
the analysis method comprising:
a first step of summing up, by the processor, the sales of the individual products at each store;
a second step of replacing, by the processor, sales of a first product at a first store with potential sales higher than the sales of the first product at the first store in a case where an attribute assigned to the first store corresponds to an attribute assigned to the first product and sales of the first product at some store assigned the attribute corresponding to the attribute assigned to the first product is higher than the sales of the first product at the first store, the first product being one of the plurality of products, and the first store being one of the plurality of stores; and
a third step of outputting, by the processor, information indicating sales ranks of the individual products at the first store after completion of the replacement with the potential sales.

2. The analysis method according to claim 1, further comprising a fourth step of assigning, by the processor, the same attribute to a plurality of stores having similar sales trends based on the sales of the individual products at each store.

3. The analysis method according to claim 2, wherein the fourth step includes:
summing up, by the processor, the sales of the individual products at each store by attribute assigned to a product; and
assigning, by the processor, an attribute accounting for the highest rate of sales to the store.

4. The analysis method according to claim 3,
wherein the second step includes replacing, by the processor, sales of a second product at the first store with potential sales higher than the sales of the second product at the first store in a case where an attribute assigned to the first store is different from an attribute assigned to the second product and sales of the second product at some store assigned an attribute corresponding to the attribute assigned to the second product is higher than the sales of the second product at the first store, the second product being one of the plurality of products, and
wherein the potential sales to replace the sales of the first product and the potential sales to replace the sales of the second product are determined by assigning weights based on a rate of summed up sales concerning the attribute assigned to the first product and a rate of summed up sales concerning the attribute assigned to the second product.

5. The analysis method according to claim 1, wherein the potential sales are the highest sales of the first product among a plurality of stores other than the first store, a value obtained by multiplying the highest sales by a predetermined coefficient, or an average of the sales of the first product at the plurality of stores other than the first store.

6. The analysis method according to claim 1, wherein the second step includes:
classifying, by the processor, products in the first store into products having high sales and products having low sales in accordance with a predetermined criterion; and
selecting, by the processor, one of the products classified as the products having low sales as the first product.

7. An analysis system comprising:
a processor; and
a storage device to be accessed by the processor,
wherein the storage device holds information indicating attributes assigned to each of a plurality of products, information indicating attributes assigned to each of a plurality of stores, and information indicating sales of individual products at each store, and
wherein the processor is configured to:
sum up the sales of the individual products at each store;
replace sales of a first product at a first store with potential sales higher than the sales of the first product at the first store in a case where an attribute assigned to the first store corresponds to an attribute assigned to the first product and sales of the first product at some store assigned the attribute corresponding to the attribute assigned to the first product is higher than the sales of the first product at the first store, the first product being one of the plurality of products, and the first store being one of the plurality of stores; and
output information indicating sales ranks of the individual products at the first store after completion of the replacement with the potential sales.

8. The analysis system according to claim 7, wherein the processor is configured to assign the same attribute to a plurality of stores having similar sales trends based on the sales of the individual products at each store.

9. The analysis system according to claim 8, wherein the processor is configured to:
sum up the sales of the individual products at each store by attribute assigned to a product; and
assign an attribute accounting for the highest rate of sales to the store.

10. The analysis system according to claim 9,
wherein the processor is configured to replace sales of a second product at the first store with potential sales higher than the sales of the second product at the first store in a case where an attribute assigned to the first store is different from an attribute assigned to the second product and sales of the second product at some store assigned an attribute corresponding to the attribute assigned to the second product is higher than the sales of the second product at the first store, the second product being one of the plurality of products, and
wherein the potential sales to replace the sales of the first product and the potential sales to replace the sales of the second product are determined by assigning weights based on a rate of summed up sales for an attribute assigned to the first product and a rate of summed up sales for an attribute assigned to the second product.

11. The analysis system according to claim 7, wherein the potential sales are the highest sales of the first product among a plurality of stores other than the first store, a value obtained by multiplying the highest sales by a predetermined coefficient, or an average of the sales of the first product at the plurality of stores other than the first store.

12. The analysis system according to claim 7, wherein the processor is configured to:
classify products in the first store into products having high sales and products having low sales in accordance with a predetermined criterion; and
select one of the products classified as the products having low sales as the first product.

13. A non-transitory computer-readable storage medium that stores an analysis program that control the computer,
wherein the computer has a processor and a storage device to be accessed by the processor,
wherein the storage device holds information indicating attributes assigned to each of a plurality of products, information indicating attributes assigned to each of a plurality of stores, and information indicating sales of individual products at each store, and
wherein the analysis program is configured to cause the processor to perform:
a first step of summing up the sales of the individual products at each store;
a second step of replacing sales of a first product at a first store with potential sales higher than the sales of the first product at the first store in a case where an attribute assigned to the first store corresponds to an attribute assigned to the first product and sales of the first product at some store assigned the attribute corresponding to the attribute assigned to the first product is higher than the sales of the first product at the first store, the first product being one of the plurality of products, and the first store being one of the plurality of stores; and
a third step of outputting information indicating sales ranks of the individual products at the first store after completion of the replacement with the potential sales.
